(19) United States
(12) Patent Application Publication
(10) Pub. No.: US 2010/0031013 A1
(43) Pub. Date: Feb. 4, 2010

(54) INJECTION MOLDING SYSTEM AND PARAMETER SETTING METHOD THEREOF

(75) Inventors: Shu-Chi Chang, Tu-Cheng (TW); Chih-Wei Hsieh, Tu-Cheng (TW); Ya-Yi Peng, Tu-Cheng (TW)

Correspondence Address: PCE INDUSTRY, INC.;ATT. Steven Reiss, 288 SOUTH MAYO AVENUE, CITY OF INDUSTRY, CA, 91789, US

(73) Assignee: FOXNUM TECHNOLOGY CO., LTD, Tucheng City (TW)

(21) Appl. No.: 12/332,356

(22) Filed: Dec. 11, 2008

(30) Foreign Application Priority Data
Jul. 30, 2008 (CN) 200810303193.2

(51) Int. Cl. G06F 9/445; G06F 9/44

(52) U.S. Cl. 713/2; 713/100

(57) ABSTRACT

An injection molding machine system for setting system parameters provides an interface unit displaying a boot interface, a common module interface, a new module setting interface, and a main operating interface. If not all the system parameter values need be modified, the system parameters are loaded on the boot interface and the main operating interface are started. If some of the system parameter values need be modified, the system parameter values are loaded, modified, and saved on the common module interface and the main operating interface are started. If all the system parameter values need be set, the system parameter values are saved on the new module setting interface and the main operating interface are started. If the system parameter values modified need be fine-tuned, the system parameter values are fine-tuned on the main operating interface.

### BACKGROUND

1. Technical Field

The invention relates to molding systems and, more particularly, to an injection molding machine system and parameter setting method thereof.

2. Description of Related Art

Injection molding machines can include many modules, such as shutdown, injection, temperature, waveform, and production control modules. Each module controls setting of different parameter values according to different products or molds.

Generally, parameter values are set by an initial setting method, used when the injection molding machine is to be operated for the first time. Alternatively, for the subsequent uses, a second method of parameter setting consists of storing all preceding parameter values set initially,, directing the system to read and set the initial setting values.

However, individual setting of the parameter values is time-consuming, especially since offsetting entry points for each module are located at different points in the control interface of the injection molding machine. If all parameter values are reset, all entry sites must be re-visited. Accordingly, repeated and complicated operations are required to set the parameter values, aggravated by a tendency in the operation interface of the injection molding machine toward less-than-user-friendly.

In addition, when product line and, accordingly, molds used by the injection molding machine change, corresponding parameter values are also needed to be changed. When new values are entered accordingly for a single module, the injection molding machine is required to re-store the complete setting file. Consequently, the injection molding machine consumes excessive internal storage resources.

What is needed, therefore, is an injection molding machine system and parameter setting method thereof which can easily control the injection molding machine and conveniently modify parameter values.

### BRIEF DESCRIPTION OF THE DRAWINGS

FIG. 1 is a block diagram of hardware structure of an injection molding machine system, in accordance with an embodiment.

FIG. 2 is a schematic view of a starting interface of the injection molding machine system of FIG. 1.

FIG. 3 is a schematic view of a common module interface of the injection molding machine system of FIG. 1.

FIG. 4 is a schematic view of a new module setting interface of the injection molding machine system of FIG. 1.

FIG. 5 is a schematic view of an operating main interface of the injection molding machine system of FIG. 1.

FIGS. 6A-6C are flowcharts of a parameter setting method for an injection molding machine system in accordance with the disclosure.

### DETAILED DESCRIPTION

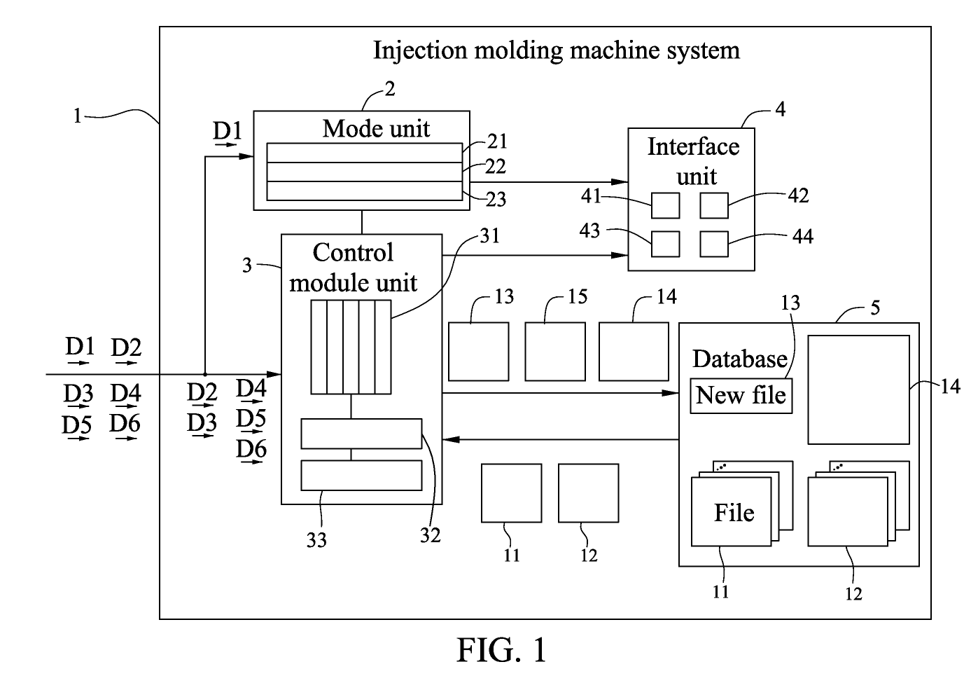

Referring to FIG. 1, an injection molding machine system 1 according to the disclosure is shown. The injection molding machine system 1 includes a mode unit 2, a control module unit 3, an interface unit 4, and a database 5.

The mode unit 2 is coupled with the interface unit 4 and the control module unit 3. The control module unit 3 is coupled with the interface unit 4 and the database 5.

The database 5 includes a plurality of files 11, each storing one or many system parameter values 12.

The mode unit 2 receives a first input instruction D1 and includes a plurality of controls enabling setting of system parameter values 12. The controls include a system last state control 21, a combination common control 22, and a new module set control 23.

The control module unit 3 includes a plurality of module classification controls 31, a parameter set control 32, and a file-name set control 33. The module classification controls 31 include a boot-shutdown control, an injection control, a wave display control, and a process control control, respectively corresponding to function modules. The boot-shutdown control corresponds to a boot-shutdown module, the injection control corresponds to an injection module, the wave display control corresponds to a wave display module, and the process control control corresponds to a process control module. The control module unit 3 receives a second input instruction D2, a third input instruction D3, a fourth input instruction D4, a fifth input instruction D5 and a selecting parameter instruction D6. The control module unit 3 also enables selection of one of the module classification controls 31 according to the second input instruction D2, modifies the system parameter values 12 of the files 11 according to the third input instruction D3 and the selecting parameter instruction D6, sets a new system parameter value 14 by selecting the parameter set control 32 according to the fourth input instruction D4, or sets a new file 13 by selecting the file-name set control 33 according to the fifth input instruction D5, and saves the new system parameter value 14 and the new file 13 in the database 5.

The interface unit 4 includes a boot interface 41, a common module interface 42, a new module setting interface 43, and a main operating interface 44.

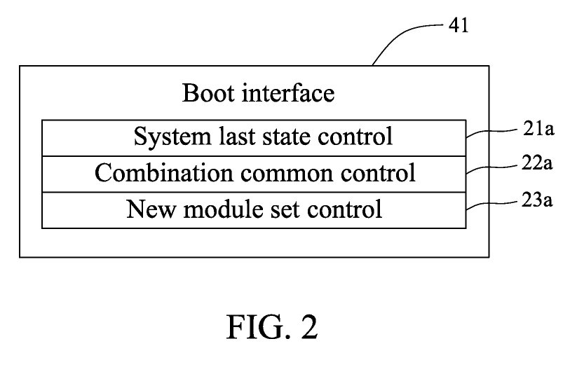

Referring to FIG. 2, the boot interface 41 includes a system last state control 21a, a combination common control 22a, and a new module set control 23a, corresponding to the mode unit 2.

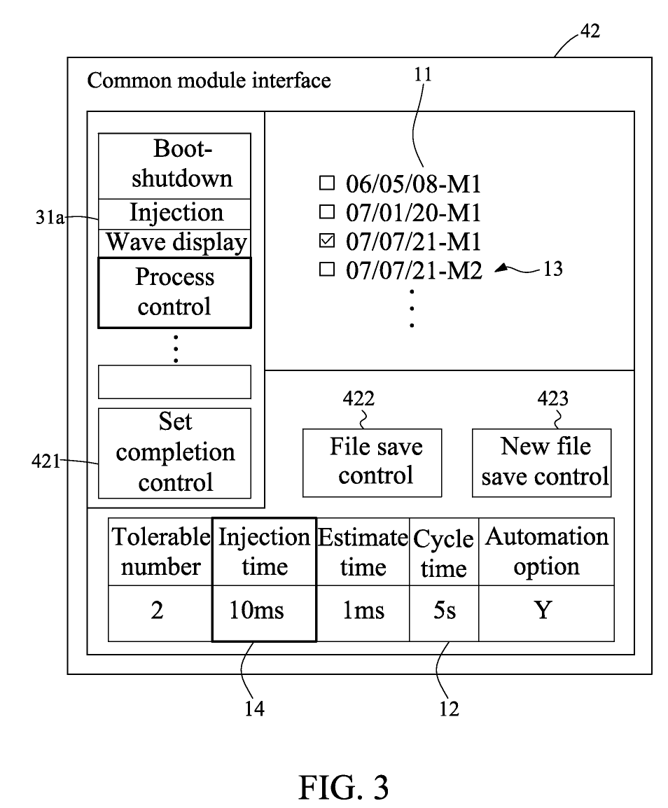

Referring to FIG. 3, the common module interface 42 includes a plurality of module classification controls 31a corresponding to the control module unit 3, a file save control 422, a new file save control 423, and a set completion control 421. The file save control 422 saves the system parameter values 12 modified in the files 11. The file save control 422 also saves the new system parameter value 14 in the new file 13 by selecting the save new file control 423. The set completion control 421 closes the common module interface 42 and starts the main operating interface 44.

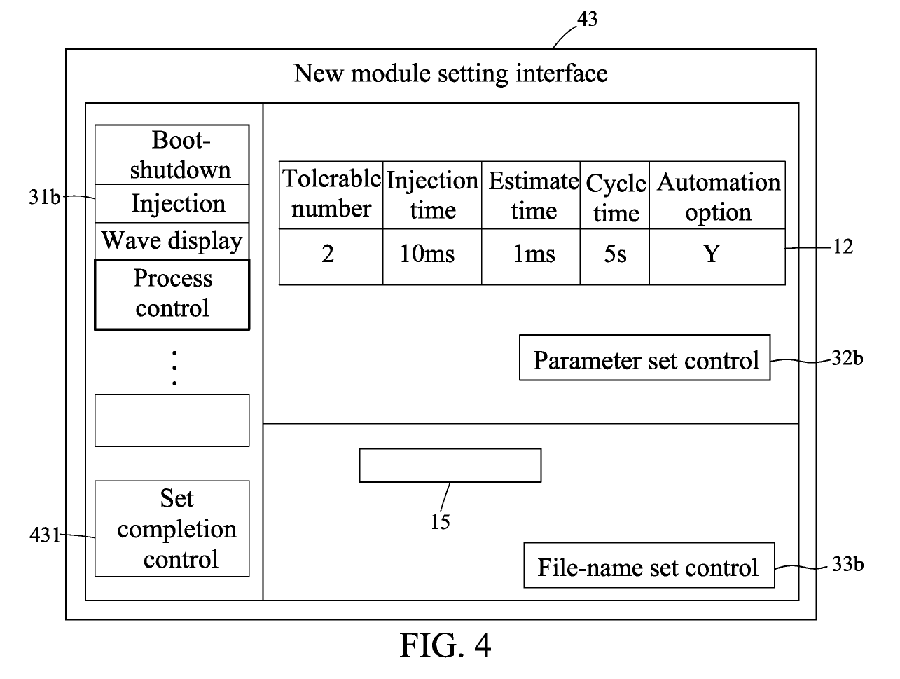

Referring to FIG. 4, the new module setting interface 43 includes a module classification control 31b corresponding to the control module unit 3, a parameter set control 32b, a file-name set control 33b, and a set completion control 431. The set completion control 431 closes the new module setting interface 43 and starts the main operating interface 44.

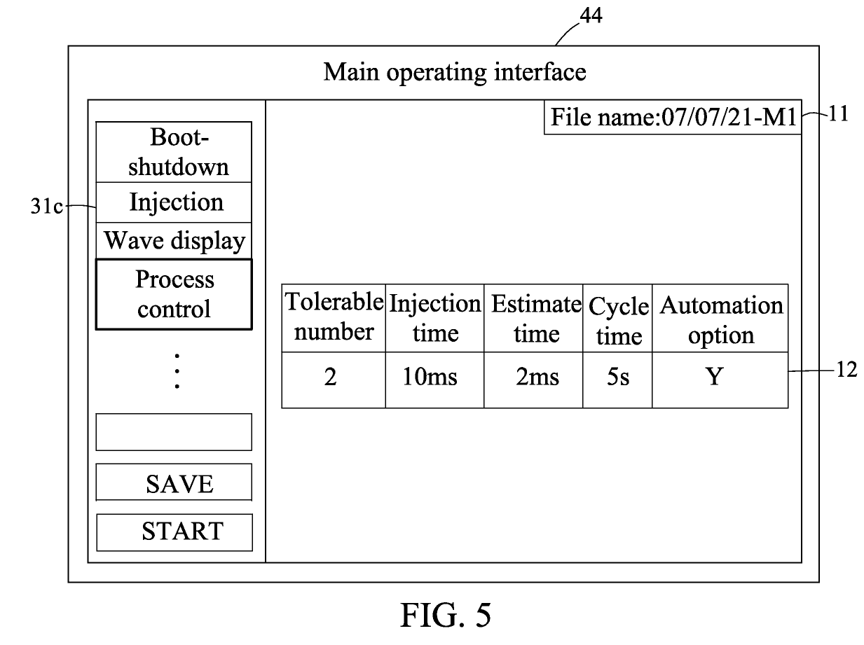

Referring to FIG. 5, the main operating interface 44 includes a module classification control 31c corresponding to the control module unit 3, a save control, and a start control.

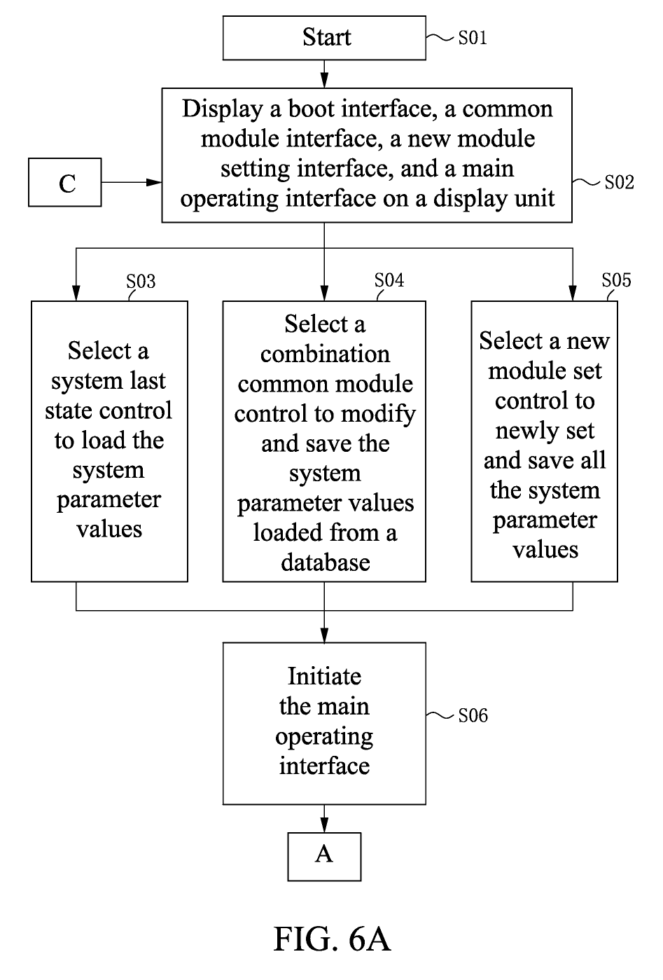

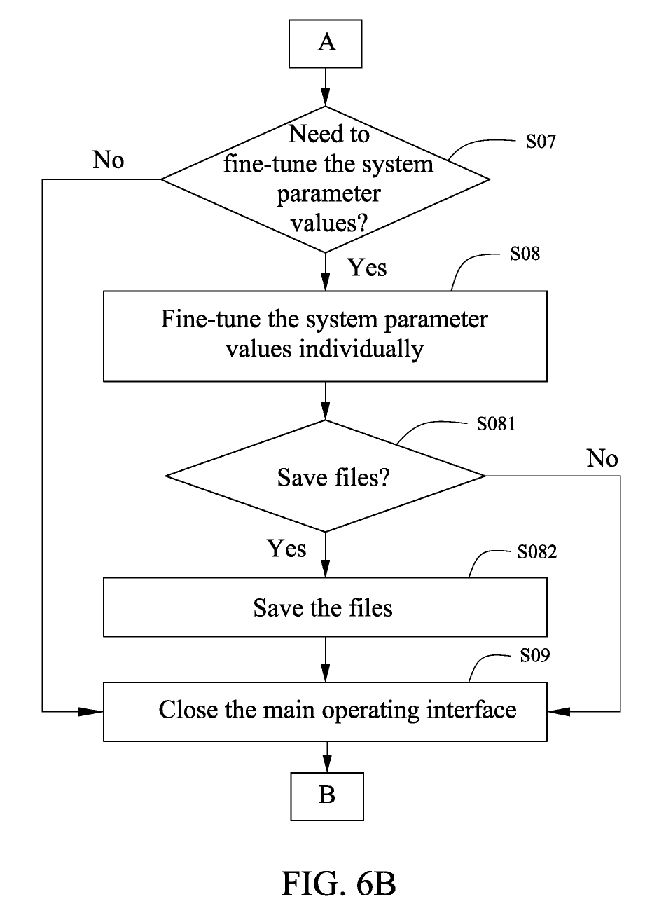

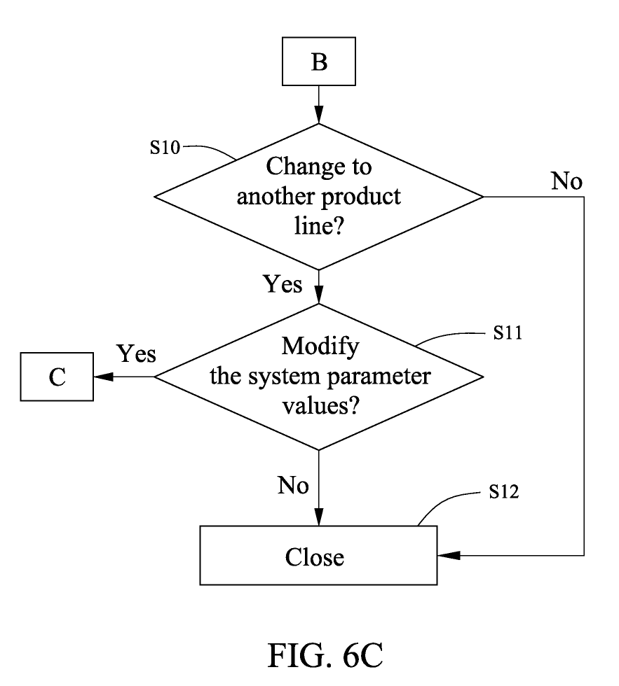

A parameter setting method for injection molding machine system 1, as shown in FIGS. 6A-6C, includes the following described steps.

In step S01, the injection molding machine system 1 starts. In step S02, the interface unit 4 displays the boot interface 41, the common module interface 42, the new module setting interface 43, and the main operating interface 44. If no system parameter values 12 of the injection molding machine system 1 need to be modified, the system last state control 21 is selected and step S03 is executed. If some parameter values 12 of the injection molding machine system 1 require modification, the combination common module control 22 is selected and the step S04 is executed. If all the system parameter values 12 of injection molding machine system 1 require resetting, the new module set control 23 is selected and step S05 is executed.

In step S03, the system parameter values 12 are loaded. The system last state control 21 is selected and the first input instruction D1 is input into the mode unit 2 to load the system parameter values 12 from the corresponding file 11 of the database 5, as seen in FIG. 1 and FIG. 2. Main operating interface 44 is started and step S06 executed.

In step S04, the system parameter values 12 loaded from the database 5 are modified and saved. Referring to FIGS. 1 to 3, the combination common module control 22 is selected. The common module interface 42 is started. The second input instruction D2 is input into the control module unit 3 and one module classification control 31a (such as process control) is selected. The interface unit 4 also displays the corresponding files 11. If one of the files 11 (such as one with a name “07/07/21-M1”) is selected to be opened, corresponding system parameters and parameter values 12 are displayed, for example, a tolerable number of a molded product of 2, an injection time of 10 ms, an estimate time being 1 ms, a cycle time of 5s, and an automation option of Y are displayed. Then, the third input instruction D3 and the selecting parameter instruction D6 are input into the control module unit 3 to select one of the parameters (such as “injection time”) and modify the corresponding parameter value 12. The “injection time” can be modified to a demanded value. The currently modified file 11 can be saved as the original file name (such as “07/07/21-M1”) by selecting the file save control 422. The currently modified file 11 can also be saved as a new file name (such as “07/07/21-M2”) by selecting the new file save control 423. When modification and save are completed, the set completion control 421 is selected to close the common module interface 42. Then, the main operating interface 44 is started and step S06 is executed.

In step S05, all the system parameter values 12 are newly set and saved. Referring to FIGS. 1, 2, and 4, the new module set control 23 is selected. The new module setting interface 43 is started. The fourth input instruction D4 and the fifth input instruction D5 are input into the control module unit 3. The parameter set control 32b is selected to set new parameters. The file-name set control 33b is selected to save all the new parameters in a new file 15. When the new parameters setting is completed, the set completion control 431 is selected to close the new module setting interface 43. Then, step S06 is executed.

In step S06, the main operating interface 44 is initiated, and as shown in FIG. 5, system parameter values 12, 14 can be fine-tuned by selecting the module classification controls 31c. For example, “estimate time” of the process control module saved in the file named “07/07/21-M1” can be adjusted from 1 ms to 2 ms and saved by selecting the save control. Fine adjustment includes the detailed steps as follow.

In step S07, the injection molding machine system 1 determines whether the system parameter values 12, 14 need to be fine-tuned. If yes, step S08 is executed. If not, step S09 is executed.

In step S08, the system parameter values 12, 14 are fine-tuned individually.

In step S081, the injection molding machine system 1 determines whether the files 11, 13 need to be saved. If yes, step S082 is executed. If not, step S09 is executed.

In step S082, files 11, 13 are saved.

In step S09, the main operating interface 44 is closed.

In step S10, the injection molding machine system 1 determines whether the product line has changed. If yes, step S11 is executed. If not, step S12 is executed.

In step S11, the injection molding machine system 1 determines whether the system parameter values 12, 14 require modification. If so, step S02 is executed. If not, step S12 is executed.

In step S12, the injection molding system 1 is closed.

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A parameter setting method for system parameters of an injection molding machine system, comprising:
providing an interface unit comprising a boot interface, a common module interface, a new module setting interface, and a main operating interface;
if all the system parameter values need not be modified, loading the system parameters on the boot interface and starting the main operating interface;
if some of the system parameter values need be modified, loading, modifying, and saving the system parameter values on the common module interface and starting the main operating interface;
if all the system parameter values need be set, loading, modifying, and saving the system parameter values on the new module setting interface and starting the main operating interface; and
if the system parameter values modified need be fine-tuned, fine-tuning the system parameter values on the main operating interface.

2. The method as claimed in claim 1, wherein if all system parameter values need not be modified, a system last state control of the boot interface is selected for loading the system parameter values.

3. The method as claimed in claim 1, wherein if some of the system parameter values need be modified, a combination common module control of the boot interface is selected to start the common module interface for loading, modifying, and saving the system parameter values.

4. The method as claimed in claim 1, wherein if all the system parameter values need be set, a new module set control is selected to start the module setting interface for loading, modifying, and saving the system parameter values newly.

5. The method as claimed in claim 1, wherein if the system parameter values modified need be fine-tuned, one module classification control is selected for fine-tuning the system parameter values.

6. The method as claimed in claim 1, further comprising, after starting the main operating interface: determining whether the system parameter values require modification when the injection molding machine system switches to a product line; if the system parameter values require modification, executing the boot interface; and closing the injection molding machine system.

7. An injection molding machine system, comprising:
a database for storing a plurality of files each comprising a plurality of system parameter values;
a mode unit comprising a system last state control, a combination common control, and a new module set control;
a control module unit comprising a plurality of module classification controls corresponding to function modules of the injection molding machine system; and
a interface unit comprising:
a boot interface for loading the system parameter values when all the system parameter values need not be modified by selecting the system last state control;
a common module interface for loading, modifying, and saving the system parameter values when some of all the system parameter values need be modified by selecting the combination common control;
a new module setting interface for loading, modifying, and saving the system parameter values when all the system parameter values need be set by selecting the file-name set control; and
a main operating interface for finely adjusting the system parameter values.

8. The injection molding machine system as claimed in claim 7, wherein the control module unit further comprises a parameter set control for setting a new system parameter value according to an input instruction.

9. The injection molding machine system as claimed in claim 7, wherein the control module unit further comprises a file-name set control for setting a new file according to an input instruction.

10. The injection molding machine system as claimed in claim 7, wherein the boot interface comprises a system last state control, a combination common control, and a new module set control, corresponding to the mode unit.

11. The injection molding machine system as claimed in claim 7, wherein the common module interface comprises a plurality of module classification controls corresponding to the control module unit, a file save control, a new file save control, and a set completion control.

12. The injection molding machine system as claimed in claim 7, wherein the new module setting interface comprises a plurality of module classification controls corresponding to the control module unit, a parameter set control, a file-name set control, and a set completion control.

13. The injection molding machine system as claimed in claim 7, wherein the main operating interface comprises a plurality of module classification controls corresponding to the control module unit, a save control, and a start control.
